(19) United States
(12) Patent Application Publication
(10) Pub. No.: US 2025/0250432 A1
(43) Pub. Date: Aug. 7, 2025

(54) PARTICLE-REINFORCED NITRILE-CONTAINING COMPOSITES

(71) Applicant: UT-Battelle, LLC, Oak Ridge, TN (US)

(72) Inventors: Christopher C. Bowland, Knoxville, TN (US); Sumit Gupta, Knoxville, TN (US); Amit K. Naskar, Knoxville, TN (US)

(21) Appl. No.: 19/008,814

(22) Filed: Jan. 3, 2025

Related U.S. Application Data
(60) Provisional application No. 63/617,459, filed on Jan. 4, 2024.

(51) Int. Cl. C08L 55/02; C08J 3/24; C08J 5/24

(52) U.S. Cl. CPC C08L 55/02; C08J 3/247; C08J 5/243; C08J 5/247; C08J 2355/02; C08J 2433/20; C08L 2205/16; C08L 2312/00

(57) ABSTRACT

A fiber reinforced composite material comprising the following components: (i) polyacrylonitrile (PAN) particles containing an acrylonitrile content of 80-100 mol % and present in an amount of 0.001-15 wt % by weight of components (i) and (ii); and (ii) a nitrile-containing polymer having a composition different than the PAN particles; wherein nitrile groups in component (i) are crosslinked with nitrile groups of component (ii), and wherein said PAN particles are dispersed in component (ii). Methods for producing the composite material, molded forms thereof, and articles thereof, are also described.

### CROSS-REFERENCE TO RELATED APPLICATIONS

The present application claims benefit of U.S. Provisional Application No. 63/617,459, filed on Jan. 4, 2024, all of the contents of which are incorporated herein by reference.

### GOVERNMENT SUPPORT

This invention was made with government support under Prime Contract No. DE-AC05-000R22725 awarded by the U.S. Department of Energy. The government has certain rights in the invention.

### FIELD OF THE INVENTION

The present invention generally relates to particle-reinforced (or more particularly fiber-reinforced) polymer composites. The present invention more particularly relates to such composites in which nitrile-containing polymers are incorporated.

### BACKGROUND

Fiber-reinforced polymer composites (FRPCs) are ubiquitous in aerospace, automotive, and renewable energy industries primarily due to their superior specific strength and resilience in aggressive environments. FRPCs are generally fabricated by incorporating continuous or chopped inorganic and organic fibers into thermosetting or thermoplastic polymers. However, due to their inherent heterogeneity, conventional FRPCs suffer from poor fiber-matrix interfacial bonding, thus hindering the fiber-matrix load transfer. Since the fiber-matrix interphase primarily dictates the mechanical properties of the bulk composites, significant efforts have been made to enhance these interphase properties. A tough interphase that is simultaneously strong and ductile is critical for maintaining structural integrity. However, such properties are often challenging to achieve due to the known inverse correlation between strength and ductility.

There would be a substantial benefit in new high-strength polymer composite materials that possess superior fiber-matrix interfacial bonding, thus maintaining a high level of strength and structural integrity in the composite during its usable lifetime. There would be a further benefit in such high-strength polymer composites if they could be made using low cost materials and produced by a low cost process.

### SUMMARY

In one aspect, the present disclosure is directed to polymer composite materials possessing exceptional strength and durability. The composites achieve this by virtue of a superior particle-matrix interfacial bonding, as further discussed below. The composites are further advantageous by being composed of low cost materials and being produced by cost effective means. Thus, the polymer composites described herein represent a significant advance in the field of high strength polymeric materials.

More particularly, the composite material includes the following components: (i) polyacrylonitrile (PAN) particles containing an acrylonitrile content of 80-100 mol % and present in an amount of 0.001-15 wt % by weight of components (i) and (ii); and (ii) a nitrile-containing polymer having a composition different than the PAN particles, wherein nitrile groups in component (i) are crosslinked with nitrile groups of component (ii), and wherein the PAN particles are dispersed in component (ii). In different embodiments, the PAN particles are present in an amount of 0.001-10 wt %, or more particularly 0.001-5 wt %, or more particularly 0.001-2 wt %. In some embodiments, including any of those above, the PAN particles are PAN fibers. The PAN fibers may have any suitable diameter, such as a diameter of about 0.01 micron to 50 microns, or a diameter of about 0.01 micron to 10 microns, or a diameter of about 0.01 micron to 1 micron. In separate or further embodiments, component (ii) is or includes a copolymer of acrylonitrile and at least one of styrene and/or butadiene, or component (ii) is more particularly selected from one or more of acrylonitrile-butadiene-styrene (ABS), styrene-acrylonitrile (SAN), nitrile-butadiene rubber (NBR), and acrylonitrile-styrene-acrylate (ASA) copolymer. In separate or further embodiments, the composite material further includes the following component: (iii) a filler component comprising particles having a composition other (different) than components (i) and (ii), wherein component (iii) is present in an amount of 0.1-60 wt % by weight of components (i) and (ii). Component (iii) may be selected from, for example, carbon particles, basalt particles, polymer particles, natural particles, ceramic particles, and glass particles. In particular embodiments, component (iii) is or includes carbon particles, or more particularly, carbon fibers.

In a second aspect, the present disclosure is directed to a method of producing a fiber reinforced composite material, the method comprising: (a1) mixing polyacrylonitrile (PAN) particles containing an acrylonitrile content of 80-100 mol % (i.e., “component (i)”) and a nitrile-containing polymer having a composition different than the PAN particles (i.e., “component (ii)”) to form a precursor mixture; or alternatively, (a2) disposing polyacrylonitrile (PAN) particles containing an acrylonitrile content of 80-100 mol % onto a filler component comprising particles having a composition other than components (i) and (ii) to produce a composite preform, and mixing the composite preform with said nitrile-containing polymer having a composition different than the PAN particles to create an infiltrated composite preform; and (b) hot-pressing the precursor mixture or infiltrated composite preform at a temperature conducive for crosslinking of nitrile groups to form the fiber reinforced composite material. In embodiments of the method, the temperature may be in the range of 160-300° C., or 200-300° C., or more particularly 220-260° C. In particular embodiments, component (ii) comprises a copolymer of acrylonitrile and at least one of styrene and/or butadiene, or component (ii) is more particularly selected from acrylonitrile-butadiene-styrene (ABS), styrene-acrylonitrile (SAN), nitrile-butadiene rubber (NBR), and acrylonitrile-styrene-acrylate (ASA) copolymer. In particular embodiments, component (ii) is or includes ABS. In some embodiments, the disposing step in step (a2) comprises electrospinning PAN particles (or fibers) containing an acrylonitrile content of 80-100 mol % onto a filler sheet in which filler fibers are woven or non-woven (randomly oriented or aligned), wherein the filler sheet with electrospun PAN particles disposed thereon corresponds to the composite preform. The electrospun PAN particles (more typically fibers) are typically in the form of a web or network of PAN particles (typically fibers).

### BRIEF DESCRIPTION OF THE FIGURES

FIG. 1. A schematic illustration showing the fiber-matrix interphase in a system with PAN nanofibers (˜0.35-μm-diameter) deposited on ˜5-μm-diameter carbon fibers to produce a hierarchical architecture covalently bonded with ABS matrix. An in-plane shear strength test was performed to characterize the composites' interfacial properties. While the representative load-displacement curve of pristine composites (i.e., the composites without any hierarchical nanofibers) exhibit weak behavior (bottom curve in graph), the nanofiber-enhanced composites are tougher with higher energy needed for fiber-matrix debonding (top curve in the graph). The C—N bond formed between PAN and ABS resulted in a co-continuous interphase between the core fiber and the matrix, which resulted in stronger and tougher composites.

FIGS. 2A-2E. Electrospun PAN nanofibers' morphology characterization. FIG. 2A shows an exemplary electrospinning setup and the parameters used in the PAN nanofiber electrospinning deposition. FIG. 2B shows a SEM image of the electrospun PAN nanofibers at different magnifications, which confirms their random yet uniform deposition. FIG. 2C is a graph showing the distribution of PAN nanofiber diameter (estimated). FIG. 2D shows how the diameter of electrospun PAN nanofiber is measured along its axis at ten equidistantly spaced points. FIG. 2E is a graph plotting the variation in diameter of the PAN nanofiber.

FIGS. 3A-3F. The extent of crosslinking in PAN-ABS composites was studied. FIG. 3A shows the chemical structures of PAN and ABS. FIG. 3B depicts the covalently bonded PAN-ABS molecule. FIG. 3C schematically depicts the melt-mixing of ABS pellets and electrospun PAN fibers using a shear mixer at a suitable temperature, such as 150° C. FIG. 3D depicts the hot-pressing of the shear-mixed PAN-ABS at different temperatures under constant pressure to obtain the PAN-ABS composite plate. FIG. 3E depicts a PAN fiber-reinforced ABS composite plate. FIG. 3F depicts the apparatus used for rheological characterization of the composites. FIG. 3G depicts the methodology used for conducting the uniaxial tensile test on the composites. FIG. 3H is a photograph showing solutions used for conducting a solubility test to validate the PAN-ABS chemical bonding.

FIGS. 4A-4J. Indirect and direct test results to validate PAN-ABS bonding. FIGS. 4A and 4B show the variation in η with angular frequency (ω) at different magnifications obtained from the rheology test, wherein FIG. 4B is a zoomed-in view of an interval of data shown in FIG. 4A. FIGS. 4C and 4D show the variation in G′ with angular frequency (ω) at different magnifications obtained from the rheology test, wherein FIG. 4D is a zoomed-in view of an interval of data shown in FIG. 4C. The units of G′ and η are Pa and Pa·s, respectively. FIGS. 4E, 4F, and 4G plot the Young's modulus, tensile strength, and toughness of the PAN-ABS composites, with six samples assessed within each set. FIG. 4H is a photograph of different specimens before the solubility tests. FIG. 4I is a photograph of the different specimens after the solubility tests. FIG. 4J shows the gel fraction of the PAN-ABS composites.

FIGS. 5A-5H. In-plane shear strength test was performed to characterize the fiber-matrix interfacial property of the composites. FIG. 5A depicts carbon fiber-ABS composites with [+45°/−45° ]2 subjected to monotonic tensile strain for in-plane shear strength characterization. FIGS. 5B and 5C summarize their τ_{IPST} and fracture energy release, respectively. FIG. 5D is a SEM micrograph showing the fractured surface of the composites. The fractured morphology of the surfaces is shown for neat ABS (FIG. 5E), (PAN-ABS)_{150° C.} (FIG. 5F), (PAN-ABS)_{220° C.} (FIG. 5G), and (PAN-ABS)_{250° C.} (FIG. 5H). For FIG. 5E-5H, the bottom SEM micrographs display the boxed region in the top SEM micrographs at a higher magnification.

FIGS. 6A-6C. PAN nanofibers with different diameters were integrated at the carbon fiber-matrix interfaces and their interfacial properties in the bulk composites were systematically analyzed. FIG. 6A is a plot of the tensile strength as a function of the PAN nanofiber diameter. FIG. 6B is a plot of the Young's modulus as a function of the PAN nanofiber diameter. FIG. 6C is a plot of the energy release during fracture as a function of the PAN nanofiber diameter. Error bars represent the standard deviation from six composite specimens.

### DETAILED DESCRIPTION

In a first aspect, the present disclosure is directed to a fiber reinforced composite material (i.e., “composite material”) containing at least (or no more than) the following components: (i) polyacrylonitrile (PAN) particles and (ii) a nitrile-containing polymer having a composition different than the PAN particles, wherein at least a portion (or all) nitrile groups in component (i) are crosslinked with nitrile groups of component (ii), and wherein the PAN particles are dispersed in component (ii). As the PAN particles are dispersed in the component (ii) polymer, the component (ii) polymer functions as a matrix for the PAN particles. If a further component (iii), such as filler particles, are also present, they may also be dispersed in the component (ii) matrix. The crosslinking of nitrile groups between components (i) and (ii) refers to the known reaction between nitrile (C≡N) groups in which a nitrogen atom of one CN group bonds to the carbon atom of another CN group to form an imine linkage of the formula —C═N—C═N—. Although the foregoing linkage is based on a dimerization reaction of two CN groups, a trimerization reaction between three CN groups may or may not also be possible.

The term “PAN particles,” as used herein, refers to particles of any shape (e.g., fibers, plates, tubes, spheres, or rings) composed of polyacrylonitrile (PAN) having an acrylonitrile content of 80-100 mol %. In one set of embodiments, the PAN particles are homopolymeric PAN, and thus, composed completely (100%) of polymerized acrylonitrile. In another set of embodiments, the PAN particles have a copolymeric composition containing acrylonitrile and one or more other polymeric units or segments thereof, such as butadiene, styrene, or acrylate. The copolymeric PAN may have any of the known copolymer arrangements, e.g., block, alternating, periodic, random, branched, or star. Some examples of copolymeric PAN particle compositions include ABS, NBR, SAN, and ASA copolymers. The copolymeric PAN composition contains less than 100% acrylonitrile, such as an acrylonitrile content of precisely or at least 80%, 85%, 90%, or 95%, but below 100%.

The PAN particles are present in the composite material in an amount of 0.001-15 wt % by weight of components (i) and (ii). In different embodiments, the PAN particles are present in an amount of precisely or about, for example, 0.001 wt %, 0.005 wt %, 0.01 wt %, 0.05 wt %, 0.1 wt %, 0.2 wt %, 0.5 wt %, 1 wt %, 2 wt %, 5 wt %, 7 wt %, 10 wt %, 12 wt %, or 15 wt %, or an amount within a range bounded by any two of the foregoing values, e.g., 0.001-12 wt %, 0.001-10 wt %, 0.001-7 wt %, 0.001-5 wt %, 0.001-2 wt %, 0.001-1 wt %, 0.001-0.5 wt %, 0.001-0.2 wt %, 0.001-0.1 wt %, 0.01-15 wt %, 0.01-12 wt %, 0.01-10 wt %, 0.01-7 wt %, 0.01-5 wt %, 0.01-2 wt %, 0.01-1 wt %, 0.01-0.5 wt %, 0.01-0.2 wt %, 0.01-0.1 wt %, 0.1-15 wt %, 0.1-12 wt %, 0.1-10 wt %, 0.1-7 wt %, 0.1-5 wt %, 0.1-2 wt %, 0.1-1 wt %, 0.1-0.5 wt %, 0.2-15 wt %, 0.2-12 wt %, 0.2-10 wt %, 0.2-7 wt %, 0.2-5 wt %, 0.2-2 wt %, 0.2-1 wt %, 0.2-0.5 wt %, 0.5-15 wt %, 0.5-12 wt %, 0.5-10 wt %, 0.5-7 wt %, 0.5-5 wt %, 0.5-2 wt %, or 0.5-1 wt %, by weight of components (i) and (ii).

In particular embodiments, the PAN particles are PAN fibers. The PAN fibers can have any of the homopolymeric or copolymeric compositions described earlier above. As known in the art, the term “fiber” indicates a shape having its length dimension longer than its width dimension. The ratio of the length to width is known as the aspect ratio. Typically, the aspect ratio of the PAN fibers is at least 10 and more typically at least 20, 50, or 100. The PAN fibers may have any of a wide range of diameters, typically at least 0.01 microns and up to 50 or 100 microns. In some embodiments, the PAN fibers have substantially uniform diameters (e.g., differing by at most or less than 50%, 20%, 10%, or 5%). In different embodiments, the PAN fibers have a diameter of precisely or about, for example, 0.01, 0.02, 0.05, 0.1, 0.2, 0.5, 1, 2, 3, 4, 5, 10, 20, 30, 40, 50, or 100 microns, or a diameter within a range bounded by any two of the foregoing values, e.g., 0.01-50 microns, 0.01-20 microns, 0.01-10 microns, 0.01-5 microns, 0.01-2 microns, 0.01-1 microns, 0.05-50 microns, 0.05-20 microns, 0.05-10 microns, 0.05-5 microns, 0.05-2 microns, 0.05-1 microns, 0.1-50 microns, 0.1-20 microns, 0.1-10 microns, 0.1-5 microns, 0.1-2 microns, or 0.1-1 microns. Moreover, while in some embodiments the PAN fibers are dispersed in component (ii) as individual unconnected fibers, in other embodiments, the PAN fibers are connected with each other, either in woven or non-woven form. The PAN fibers may be produced by any method known in the art. In some embodiments, the PAN fibers are produced by an electrospinning process.

Notably, smaller sized PAN particles (or more particularly, fibers) can generally be incorporated into the composite material in substantially smaller amounts than larger sized PAN particles to achieve the same or similar effect, which is by virtue of the greater surface area of smaller sized PAN particles compared to larger sized PAN particles. For example, whereas PAN fibers having a diameter in a range of 0.01-1 micron may be incorporated in an amount of 0.001-2 wt % to achieve acceptable physical properties, PAN fibers having a diameter in a range of 2-10 microns may be incorporated in an amount of 3-15 wt % or 3-10 wt % to achieve similar acceptable properties.

Component (ii), the nitrile-containing polymer, has a composition different from the PAN particles. In particular embodiments, component (ii) is or includes a copolymer of acrylonitrile and at least one of styrene and/or butadiene. Some examples of such copolymers include acrylonitrile-butadiene-styrene (ABS), styrene-acrylonitrile (SAN), nitrile-butadiene rubber (NBR), and acrylonitrile-styrene-acrylate (ASA) copolymer. The at least two types of units in the nitrile-containing copolymer are often present in the copolymer in random form, but may alternatively be present as blocks (i.e., segments), or in alternating, periodic, branched, or graft form. Any of the copolymers may include one or more other monomer units, such as one or more of styrene, divinyl benzene, isoprene, acrylate, and/or methacrylate units. In some embodiments, a nitrile butadiene rubber (NBR) containing only acrylonitrile and butadiene units is used, while in other embodiments a nitrile butadiene rubber containing one or more additional monomeric units, such as any of those above, is/are included. In particular embodiments, component (ii) is or includes ABS. Although not typical, component (ii) may be homopolymeric PAN, but in such a case, component (i) should have a copolymeric composition since components (i) and (ii) are required to be compositionally different.

The nitrile-containing polymer component (or specifically, ABS or NBR component) can also have any of a wide range of weight-average molecular weights (M_{w}), such as precisely, about, at least, above, up to, or less than, for example, 2,500 g/mol, 3,000 g/mol, 5,000 g/mol, 10,000 g/mol, 50,000 g/mol, 100,000 g/mol, 150,000 g/mol, 200,000 g/mol, 300,000 g/mol, 400,000 g/mol, 500,000 g/mol, or 1,000,000 g/mol, or a molecular weight within a range bounded by any two of the foregoing exemplary values. The nitrile-containing polymer may also have any of a wide range of number-average molecular weights Mₙ, wherein n can correspond to any of the numbers within the range provided above for M_{w}.

The nitrile-containing polymer (or specifically, ABS or NBR component) can have any acrylonitrile content known in the art. In some embodiments, the nitrile-containing polymer has an acrylonitrile content of at least or above 20 mol %. In different embodiments, the nitrile-containing polymer has an acrylonitrile content of about, at least, or above 20, 25, 30, 33, 35, 38, 40, 42, 45, 48, 50, 52, 55 or 60 mol %, or an acrylonitrile content within a range bounded by any two of the foregoing values.

The most common commercial ABS or NBR grades contain approximately 25-50 mole % acrylonitrile. The higher the acrylonitrile content, the higher the T_{g} and hardness of the NBR or ABS. To further enhance acrylonitrile content in the nitrile-containing polymer of component (ii), in some embodiments, homopolymeric polyacrylonitrile (synthesized and purified in dry powder form) can be mixed with a nitrile-containing copolymer, or more specifically, mixed with ABS, NBR, SAN, or ASA copolymers to form a polymer blend for component (ii). Such addition of PAN to a nitrile-containing copolymer, such as NBR, ABS, SAN, or ASA, can increase acrylonitrile content in component (ii) to a level of at least or above 50 mol %, 55 mol %, or 60 mol %.

Notably, any PAN particle composition described earlier above can be incorporated (dispersed) into any nitrile-containing polymer or copolymer described above, provided that the PAN particle composition and nitrile-containing polymer or copolymer compositions are different. As noted earlier above, at least a portion (e.g., at least 50%, 60%, 70%, 80%, or 90%) or all (100%) nitrile groups in component (i) are crosslinked with nitrile groups of component (ii) in the composite material, which provides an exceptionally strong interface between the PAN particles and component (ii) matrix.

In some embodiments, the composite material further includes the following component: (iii) a filler component containing particles having a composition other than components (i) and (ii). The filler component is typically present in an amount of 0.1-60 wt % by weight of components (i) and (ii). In different embodiments, the filler component is present in an amount of precisely or about, for example, 0.1 wt %, 0.2 wt %, 0.5 wt %, 1 wt %, 2 wt %, 5 wt %, 10 wt %, 15 wt %, 20 wt %, 25 wt %, 30 wt %, 35 wt %, 40 wt %, 45 wt %, 50 wt %, 55 wt %, or 60 wt %, or an amount within a range bounded by any two of the foregoing values, e.g., 0.1-50 wt %, 0.1-40 wt %, 0.1-30 wt %, 0.1-20 wt %, 0.1-10 wt %, 0.1-5 wt %, 0.1-2 wt %, 0.1-1 wt %, 0.5-60 wt %, 0.5-50 wt %, 0.5-40 wt %, 0.5-30 wt %, 0.5-20 wt %, 0.5-10 wt %, 0.5-5 wt %, 0.5-2 wt %, 0.5-1 wt %, 1-60 wt %, 1-50 wt %, 1-40 wt %, 1-30 wt %, 1-20 wt %, 1-10 wt %, or 1-5 wt %. In some embodiments, the filler component is present in an amount of at least 0.05 wt % or 0.005 wt %, or an amount within a range in which a minimum is selected as 0.05 wt % or 0.005 wt % and a maximum is selected as any of the exemplary values provided above. The filler component may be or include, for example, carbon particles, basalt particles, polymer particles, natural particles (e.g., cellulose or lignin), ceramic particles (e.g., metal oxides, carbides, nitrides, or borides), or glass particles. In some embodiments, any one or more of the above filler components (or all filler components other than PAN particles) is/are excluded from the composite material. In some embodiments, the composite material is composed of only components (i) and (ii).

In particular embodiments, the filler particles of component (iii) are filler fibers. While in some embodiments the filler fibers are dispersed in component (ii) as individual unconnected fibers, in other embodiments, the filler fibers are connected with each other, either in woven or non-woven form, wherein the non-woven form includes a network of filler fibers bonded at random points or a bonded assembly of aligned filler fibers (as a sheet). The filler fibers and arrangements thereof can be produced by methods well known in the art.

In one set of embodiments, filler particles having a ceramic composition (i.e., “ceramic particles”) are present in the composite material. The ceramic particles can have any of the known ceramic compositions, such as ceramic oxide, ceramic sulfide, ceramic nitride, ceramic carbide, and ceramic boride compositions. Typically, the ceramic composition includes one or more metallic and/or metalloid (main group) elements bonded with oxygen, sulfur, nitrogen, phosphorus, carbon, silicon, or boron atoms, or a combination of two or more of such atoms. The metallic elements include the alkaline earth, transition metal, and lanthanide elements, as found in Groups 2-12 of the Periodic Table. The metalloid elements include the main group metals (typically, Groups 13-15 of the Periodic Table). Thus, the ceramic composition may be, for example, an alkaline earth oxide, transition metal oxide, main group oxide (e.g., glass, silica, alumina, titania, zirconia, yttria, and the like), lanthanide oxide, alkaline earth sulfide, transition metal sulfide, main group sulfide, lanthanide sulfide, alkaline earth nitride, transition metal nitride, main group nitride, lanthanide nitride, alkaline earth carbide, transition metal carbide, main group carbide, lanthanide carbide, alkaline earth boride, transition metal boride, main group boride, and lanthanide boride. Ceramic particles, including nanoparticles and microparticles of any of these, are well known in the art. Moreover, the ceramic composition may correspond to a natural mineral composition, such as any of mullite, quartz, basalt, and clays. The ceramic composition may alternatively be a natural or synthetic zeolite. In some embodiments, the ceramic particles are shaped as fibers, plates, spheres, or are amorphous. The ceramic particles may be nanoparticles (e.g., at least 1, 2, 5, or 10 nm, and up to 20, 50, 100, 200, or 500 nm), microparticles (e.g., at least 1, 2, 5, or 10 μm, and up to 20, 50, 100, 200, or 500 μm), or macroparticles (e.g., above 500 μm, or at least or up to 1, 2, 5, 10, 20, 50, or 100 mm), wherein the foregoing sizes may correspond to at least one, two, or all dimensions of the particles, wherein the three dimensions of each particle may be the same or different and independently selected from any of the values provided above.

In another set of embodiments, filler particles having a carbon composition (i.e., “carbon particles”) are present in the composite material. The carbon particles may be in place of or in combination with ceramic particles. The carbon particles can be any of the carbon particles known in the art that are composed substantially of elemental carbon. The carbon particles may be nanoparticles (e.g., at least 1, 2, 5, or 10 nm, and up to 20, 50, 100, 200, or 500 nm), microparticles (e.g., at least 1, 2, 5, or 10 μm, and up to 20, 50, 100, 200, or 500 μm), or macroparticles (e.g., above 500 μm, or at least or up to 1, 2, 5, 10, 20, 50, or 100 mm). Some examples of carbon particles include carbon black (“CB”), graphene, graphene oxide, graphene nanoribbons, carbon onion (“CO”), spherical fullerenes (e.g., buckminsterfullerene, i.e., C₆₀, as well as any of the smaller or larger buckyballs, such as C₂₀ or C₇₀), tubular fullerenes (e.g., single-walled, double-walled, or multi-walled carbon nanotubes), carbon nanodiamonds, and carbon nanobuds, all of which are well known in the art. As known in the art, fully graphitized carbon nanodiamonds can be considered carbon onions. In some embodiments, the filler component excludes carbon particles.

In some embodiments, the carbon particles are composed solely of carbon. In other embodiments, the carbon particles are doped with one or a combination of non-carbon non-hydrogen (i.e., hetero-dopant) elements, such as nitrogen, oxygen, sulfur, boron, silicon, or phosphorus. The amount of doping element is often a minor amount (e.g., up to 0.1, 0.5, 1, 2, or 5 wt. % or mol %) but may be significantly higher (e.g., at least 5, 10, or 20 mol %), particularly in the case of oxygen as dopant. In some embodiments, the carbon particles are selected from graphene, graphene oxide, or a combination thereof. Graphene oxide can have 5-30% heteroatom (oxygen) content. In some embodiments, highly oxidized (oxygen content up to 50%) graphene oxide is used as carbon-based particle. In some embodiments, any one or more of the specifically recited classes or specific types of carbon particles are excluded, or any one or more of the specifically recited classes or specific types of hetero-dopant elements are excluded from the carbon particles.

In some embodiments, the carbon particles can be any of the high strength carbon fiber compositions known in the art. As known in the art, the carbon fiber has its length dimension longer than its width dimension. Carbon fibers can be relatively short (e.g., 1-10 cm) or of typical length (e.g., 0.1 m, 1 m, or longer). Some examples of carbon fiber compositions include those produced by the pyrolysis of polyacrylonitrile (PAN), viscose, rayon, pitch, lignin, polyolefins, as well as vapor grown carbon nanofibers, any of which may or may not be heteroatom-doped, such as with nitrogen, boron, oxygen, sulfur, or phosphorus. The carbon fiber typically possesses a high tensile strength, such as at least 500, 1000, 2000, 3000, 5000, 7,000, or 10,000 MPa, or higher, with a degree of stiffness generally of the order of steel or higher (e.g., 100-1000 GPa). The carbon particles may also be chopped versions of a carbon fiber, typically having lengths within a range of 10-1000 microns. In some embodiments, carbon fibers or particles derived therefrom are excluded from the composite material.

Component (iii) filler particles, if present, may or may not be surface functionalized. In one set of embodiments, the filler particles are not surface functionalized (i.e., they are bare). In another set of embodiments, the filler particles are surface functionalized. The surface functionalization may be provided by discrete surface functional groups or polymers. The surface functional groups may be, for example, hydroxy, carboxy, amine, epoxy, or thiol groups, or an alkyl or alkenyl chain (or surfactant) containing one or more of any of the foregoing groups. The surface functional polymer may be, for example, a polysiloxane, polyether, polyamine, or polyimine. Particles containing different functional groups may also be used.

In some embodiments, the PAN particles (or more particularly, PAN fibers) are disposed on (i.e., bonded or physisorbed to) component (iii) filler particles. Typically, the size of the component (iii) filler particles are larger (e.g., at least 10%, 50%, 100%, 200%, 500%, or 1000% in at least one or two of their dimensions) than the PAN particles. Such an arrangement may herein be referred to as a hierarchical structure. In particular embodiments, the PAN particles (or more particularly, PAN fibers) are disposed on carbon or basalt fibers that have a substantially larger diameter than the PAN particles (or fibers). The PAN particles may be disposed on the component (iii) filler particles by any means known in the art, such as by coating or electrospinning the PAN particles onto the component (iii) filler particles, wherein the component (iii) particles may be in non-bonded form or bonded form (e.g., woven or non-woven) when the PAN particles are disposed onto them. In particular embodiments, PAN fibers are disposed on substantially larger carbon or basalt fibers that are non-bonded or bonded (e.g., woven or non-woven sheet or sponge). Notably, in the case of a bonded arrangement of component (iii) filler particles, the component (ii) matrix is permeated through all the fiber-fiber interspaces in the composite material.

The composite material described herein may or may not include a modifying agent other than the components (i)-(iii) described above. For example, in some embodiments, an additional agent that favorably modifies the physical properties (e.g., tensile strength, modulus, and/or elongation) may be included. The modifying agent may be selected from, for example, ether-containing polymers, Lewis acid compounds (e.g., boron-containing compounds), solvents, and/or plasticizers. The modifying agent may be dissolved or dispersed into the component (ii). In some embodiments, one or more such modifying agents are each independently, or in total, present in an amount of up to or less than 40, 30, 20, 15, 10, 5, 4, 3, 2, or 1 wt. % of the composite material. In other embodiments, one or more of the above modifying agents are excluded from the composite material.

An ether-containing polymer, if present in the composite material as a modifying agent, can be, for example, a polyalkylene oxide (i.e., polyethylene glycol) or a copolymer thereof. Some examples of polyalkylene oxides include the polyethylene oxides, polypropylene oxides, polybutylene oxides, and copolymers thereof or with ethylene, propylene, or allyl glycidyl ether. The ether-containing polymer may also be, for example, a polyvinyl cyanoethyl ether, as described in, for example, U.S. Pat. No. 2,341,553, the contents of which are herein incorporated by reference. The ether-containing polymer may also be, for example, an etherified form of PVA, such as poly(vinyl methyl ether), which may correspond to CAS No. 9003-09-2. The ether-containing polymer may also be, for example, a phenyl ether polymer, which may be a polyphenyl ether (PPE) or polyphenylene oxide (PPO). The ether-containing polymer may also include cyclic ether groups, such as epoxide or glycidyl groups, or as further described in, for example, U.S. Pat. No. 4,260,702, the contents of which are herein incorporated by reference. The cyclic ether polymer may also be a cyclic anhydride modified polyvinyl acetal, as further described in U.S. Pat. No. 6,555,617, or a cyclic or spirocyclic polyacetal ether, as further described in, for example, A. G. Pemba, et al., Polym. Chem., 5, 3214-3221 (2014), the contents of which are herein incorporated by reference. In yet other embodiments, the ether-containing polymer may be a cyclic or non-cyclic thioether-containing polymer, such as a polyphenyl thioether or polyphenylene sulfide. In some embodiments, any one or more classes or specific types of the foregoing ether-containing polymers are excluded from the composite material.

A Lewis acid compound, if present in the composite material as a modifying agent, can be any of the compounds known in the art having Lewis acid character, i.e., strongly electrophilic by virtue of a deficiency of electrons, other than any Lewis compounds (e.g., halides, oxides, carboxylates, sulfates, or nitrates of Group 13 elements) described above. Some examples of Lewis acid compounds that may be included in the composite material include boron-containing compounds (e.g., boric acid and boranes), aluminum-containing compounds (e.g., aluminum hydroxide), and tin-containing compounds (e.g., stannic acid and tin (IV) ethoxide). In some embodiments, any one or more classes or specific types of the foregoing Lewis acid compounds are excluded from the composite material.

A halogen-containing polymer, if present in the composite material as a modifying agent, can be any of the known halogen-containing polymers. The halogen-containing polymer typically contains halogen atoms bound to aliphatic (i.e., non-aromatic, e.g., alkyl or alkenyl) or aromatic groups. The halogen atoms can be, for example, fluorine, chlorine, and bromine atoms. Some examples of fluorinated polymers include poly(vinyl fluoride), poly(vinylidene fluoride), poly(tetrafluoroethylene), fluorinated ethylene-propylene copolymer, poly(ethylenetetrafluoroethylene), poly(perfluorosulfonic acid), and fluoroelastomers. Some examples of chlorinated polymers include poly(vinyl chloride), polyvinylidene chloride, ethylene-chlorotrifluoroethylene copolymer, polychloroprene, halogenated butyl rubbers, chlorinated polyethylene, chlorosulfonated polyethylene, chlorinated polypropylene, chlorinated ethylene-propylene copolymer, and chlorinated polyvinyl chloride. Some examples of brominated polymers include poly(vinyl bromide), and brominated flame retardants known in the art, such as brominated epoxy, poly(brominated acrylate), brominated polycarbonate, and brominated polyols. In some embodiments, any one or more classes or specific types of halogen-containing polymers are excluded from the composite material.

In some embodiments, a metal salt is included in the composite material as a modifying agent. In other embodiments, a metal salt is excluded from the composite material. The metal salt may contain, for example, monovalent, divalent, or trivalent metal ions, and these may be in association with one or more of the known anions, such as halides (e.g., fluoride, chloride, or bromide), carboxylates, sulfates, or nitrates. In some embodiments, the metal salt being included or excluded is a metal halide, or a specific type of metal halide, such as a divalent metal halide or trivalent metal halide, or alkaline earth metal halide, or main group metal (divalent or trivalent) halide, or transition metal (divalent or trivalent) halide. In yet other embodiments, monovalent (e.g., alkali) metal salts, tetravalent metal salts, pentavalent metal salts, or hexavalent metal salts may be included or excluded from the composite material.

The composite material preferably possesses a tensile strength (or “yield stress,” “tensile stress,” or “tensile yield strength”) of at least or above 5 MPa. In different embodiments, the tensile yield stress is at least or above 5 MPa, 8 MPa, 10 MPa, 12 MPa, 15 MPa, 20 MPa, 25 MPa, or 30 MPa, or a yield stress within a range bounded by any two of the foregoing exemplary values. As understood in the art, the term “tensile yield strength” or “yield stress” refers to the stress maxima in the stress-strain curve experienced by the composite during tensile deformation just after the linear elastic region; materials deformed beyond the yield stress usually show permanent deformation. Beyond the “tensile yield stress” point in the stress-strain profile of the material, the stress experienced by the material during stretching may remain less than that of the yield stress. Thus, “tensile strength” is defined at the stress experienced by the material at fracture or failure point can be lower than the yield strength. In some materials, the tensile stress experienced at failure is significantly higher than that of the yield stress. In such cases, the stress-strain curve shows a rise (sometimes steep rise) in stress with increase in strain due to enhanced molecular orientation along the direction of deformation. Such a phenomenon of increase in the stress at large strain values (as the polymer molecules orient) is known as “strain hardening”.

For some of the exemplary yield stress values provided above, the tensile strength (i.e., the tensile stress experienced at failure, i.e., “tensile failure strength” or “ultimate tensile strength”) of the composite material will be higher according to the known difference in how yield stress and tensile failure strength are defined. The composite material preferably possesses a tensile failure strength of at least or above 10 MPa. In different embodiments, the composite material may exhibit a tensile failure strength of at least or above, for example, 10 MPa, 12 MPa, 15 MPa, 20 MPa, 25 MPa, 30 MPa, 35 MPa, 40 MPa, 45 MPa, or 50 MPa, or a tensile failure strength within a range bounded by any two of the foregoing exemplary values. In some embodiments, the composite material does not exhibit strain hardening; it fails at a stress below the yield stress while stretching. Any of the above tensile yield strengths can be exhibited while at an elongation or strain of at least or above 0.1%, 0.2%, 0.5%, 1, 10%, 20%, or 50%. The strain corresponding to the yield stress is called “yield strain”. In other embodiments, the composite material does not show a prominent yield stress.

The composite material preferably possesses an ultimate elongation (i.e., elongation at break) of at least or above the yield strain. In some embodiments, the composite material possesses an ultimate elongation of at least or above 20%. In different embodiments, the composite material may exhibit an ultimate elongation of at least or above 20%, 50%, 100%, 110%, 120%, 150%, 180%, 200%, 250%, 300%, 350%, 400%, 450%, or 500%, or an ultimate elongation within a range bounded by any two of the foregoing exemplary values. In some embodiments, the composite material possesses any of the above preferable elongation characteristics along with any of the preferable yield stress or tensile strength characteristics, also provided above.

In some embodiments, the composite material exhibits a tensile stress or tensile failure strength of at least or above 5 MPa or 10 MPa at 1% elongation. In other embodiments, the composite material exhibits a tensile stress or tensile failure strength of at least or above 5 MPa or 10 MPa at 10% elongation. In some embodiments, the tensile stress at 10% elongation is at least or above 10 MPa. In specific embodiments, the tensile stress at 50% elongation is at least or above 5 MPa, 10 MPa, 15 MPa, 20 MPa, 30 MPa, 40 MPa, or 50 MPa. In some embodiments, the tensile stress at 100% elongation is at least or above 5 MPa, 10 MPa, 15 MPa, 20 MPa, 30 MPa, or 50 MPa.

In particular embodiments, the composite material possesses a yield stress or tensile failure strength of at least or above 10 MPa, 15 MPa, 20 MPa, 25 MPa, 30 MPa, 40 MPa, or 50 MPa along with an ultimate elongation of at least or above 20%, 30%, 40%, 50%, 100%, 150%, 180%, 200%, 250%, or 300%. Moreover, in some embodiments, the composite material exhibits strain hardening during mechanical deformation, such as during stretching beyond yield strain to ultimate failure.

In another aspect, the present disclosure is directed to methods for producing the composite material described above. In an exemplary method, at least (or only) the components (i) and (ii) (and optionally, a component (iii) and/or one or more modifying agents, as discussed above) are mixed and homogeneously blended to form a precursor mixture. The foregoing step may herein be referred to as step (a1). The PAN particles (component (i)) can have any of the shapes (e.g., fibers) and compositions described earlier above. The nitrile-containing polymer (component (ii)) can have any of the compositions described earlier above, provided that the nitrile-containing polymer has a composition different than the PAN particles. Any of the relative amounts by weight of components (i), (ii), and (iii), as described above, can be used in the process to result in a precursor mixture containing the same relative amounts of components. Component (ii) can be included in melted form (if applicable), in solution form, or in particulate or granular form. Typically, if component (ii) or a modifying agent is provided in particle or granular form, the particles are melted or softened by appropriate heating to permit homogeneous blending and uniform dispersion of the components. The components can be homogeneously blended by any of the methodologies known in the art for achieving homogeneous blends of solid, semi-solid, gel, paste, or liquid mixtures. Some examples of applicable blending processes include simple or high-speed mixing, shear mixing, compounding, extrusion, or ball mixing, all of which are well-known in the art. In some embodiments, the nitrile-containing polymer of component (ii) is in solid bale form, which can be cut into useable chunks using standard bale cutting tools. Chunks of different sizes can be mixed or blended with other component(s) in an internal mixer (such as Banbury mixer). In other embodiments, the nitrile-containing polymer is mixed or blended with component(s) in a ball mill. In other embodiments, the nitrile-containing polymer is in sheet form and the components are mixed in a two-roll mill. The precursor mixture, as formed above, is then hot-pressed at a temperature conducive for crosslinking of nitrile groups (between PAN particles and component (ii) polymer) to form the particle-reinforced composite material described above.

In an alternative process, the PAN particles are first disposed onto a filler component comprising particles having a composition other than components (i) and (ii) to produce a composite preform. As noted earlier above, in some embodiments, the filler component is comprised of fibers (e.g., carbon or basalt fibers) that may be non-bonded or bonded (e.g., woven or non-woven). The PAN particles (or more particularly, PAN fibers) are disposed on any of these types of filler particles or arrangements thereof. In particular embodiments, PAN particles (or more particularly, PAN fibers, nanofibers, or nanofiber webs/networks) are electrospun onto filler particles or bonded arrangements thereof (e.g., unidirectional, woven, or non-woven sheet of filler fibers). Typically, the PAN particles (or fibers) that are electrospun or otherwise deposited onto filler fibers have a smaller size (or more particularly, diameter) than the filler fibers, thereby forming a hierarchical structure. The smaller size (e.g., diameter) may be, for example, at least ten-times smaller than the size of the filler fibers. The PAN particles are bonded to the filler component typically by physisorption, but covalent, hydrogen, or ionic bonding may or may not also be present. The composite preform is mixed or otherwise impregnated or infiltrated with the nitrile-containing polymer, i.e., component (ii), having a composition different than the PAN particles to create an infiltrated composite preform. The foregoing step of producing a composite preform and mixing it with component (ii) to form the infiltrated composite preform may herein be referred to as step (a2). The infiltrated composite preform, as formed above, is then hot-pressed at a temperature conducive for crosslinking of nitrile groups between PAN particles and component (ii) polymer to form the particle-reinforced composite material. The PAN particles (component (i)) can have any of the shapes (e.g., fibers) and compositions described earlier above. The nitrile-containing polymer (component (ii)) can have any of the compositions described earlier above, provided that the nitrile-containing polymer has a composition different than the PAN particles. The filler component (component (iii)) can have any of the shapes and compositions described earlier above.

The temperature at which the precursor mixture or infiltrated composite preform is hot-pressed to crosslink nitrile groups and form the particle-reinforced composite material is typically at least 160° C. or 180° C. In different embodiments, the hot-pressing temperature is precisely or about, for example, 160° C., 170° C., 180° C., 190° C., 200° C., 210° C., 220° C., 230° C., 240° C., 260° C., 270° C., 280° C., 290° C., or 300° C., or a temperature within a range bounded by any two of the foregoing values, e.g., 160-300° C., 170-300° C., 180-300° C., 190-300° C., 200-300° C., 210-300° C., 220-300° C., 230-300° C., 240-300° C., 250-300° C., 160-260° C., 170-260° C., 180-260° C., 190-260° C., 200-260° C., 210-260° C., 220-260° C., 230-260° C., 160-240° C., 170-240° C., 180-240° C., 190-240° C., 200-240° C., 210-240° C., 220-240° C., 160-220° C., 170-220° C., 180-220° C., 190-220° C., 200-220° C., 160-200° C., 170-200° C., or 180-200° C.

The composite material may be subjected to a shape-forming process to produce a desired shape of the composite material. The shape-forming process can include, for example, additive manufacturing (AM), extrusion molding (e.g., pour, injection, or compression molding), resin transfer molding, melt pressing, or stamping, all of which are well known in the art. In some embodiments, the composite material is used in a printing process to form a shape containing the composite material, wherein the printing process can be, for example, a rapid prototyping (RP) process known in the art, such as a fused deposition modeling (FDM) or fused filament fabrication (FFF) process known in the art, which may also be collectively considered as 3D printing processes. The molded objects may be subjected to the crosslinking temperature during or after the molding process. A convection oven can be used for annealing of initially molded blends. During annealing, the composite components undergo both stress relaxation and crosslinking.

In another aspect, the invention is directed to an article containing the composite material described above. The article is typically one in which some degree of toughness is desired along with high mechanical strength. The composite material used in the article may contain any combination of components (i) and (ii) described above, and may or may not also include a filler and/or modifying component, as described above. The article may be used as or included in any useful component, such as a structural support, the interior or exterior of an automobile, aircraft, furniture, tool or utensil, or a high strength sheet or plate. In some embodiments, the composite material may be produced and applied as a coating or film, such as a protective coating or film. The composite material may be rendered as a coating or film by, for example, dissolving the components of the composite in a suitable solvent, followed by application of the liquid onto a suitable substrate followed by solvent removal.

Examples have been set forth below for the purpose of illustration and to describe certain specific embodiments of the invention. However, the scope of this invention is not to be in any way limited by the examples set forth herein.

### Examples

### Preparation of a PAN-ABS-CF Composite Material

For demonstration, poly(acrylonitrile-butadiene-styrene) (ABS), electrospun polyacrylonitrile (PAN) nanofibers, and carbon fiber (CF) were selected as the polymer matrix, the nanofiber scaffold, and the core fiber, respectively. The carbon fiber possesses a diameter that is approximately an order of magnitude larger than that of electrospun nanofibers, thereby establishing a hierarchical network at the core fiber-matrix interphase. PAN and ABS have compatible nitrile groups that can aid the desired hierarchical nanostructures-matrix molecular coupling when subjected to suitable thermal stimuli. Electrospinning was used as a scalable and low-cost method to integrate the high aspect ratio PAN nanofibers at the fiber-matrix interphase.

### Materials

Unidirectional carbon fiber sheets and ABS pellets were obtained from commercial sources. PAN powder was obtained from a commercial source and is a copolymer of 95.36 mol. % acrylonitrile and 4.64 mol. % methyl acrylate. The PAN has a molecular weight of 126 kDa and polydispersity of 2.23.

### Electrospinning

A 5 wt. % PAN dope was prepared by mixing ˜99 g of PAN powder in 20 mL of DMF for electrospinning. The mixture was mechanically stirred with a magnetic stirrer at 300 rpm for 48 hours until all the PAN powder was dissolved, resulting in a clear golden-yellowish solution that was utilized for electrospinning. The dope was loaded into a syringe with a blunt tip needle for the electrospinning process. The PAN nanofibers were collected on two different substrates (i.e., aluminum foil, unidirectional carbon fiber sheets) and used in experiments.

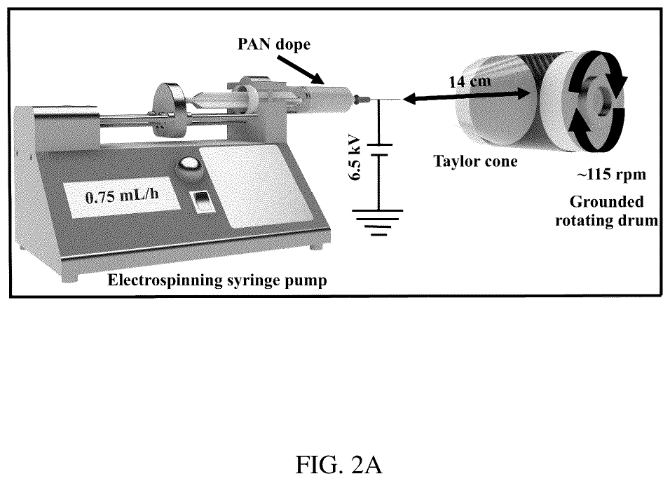

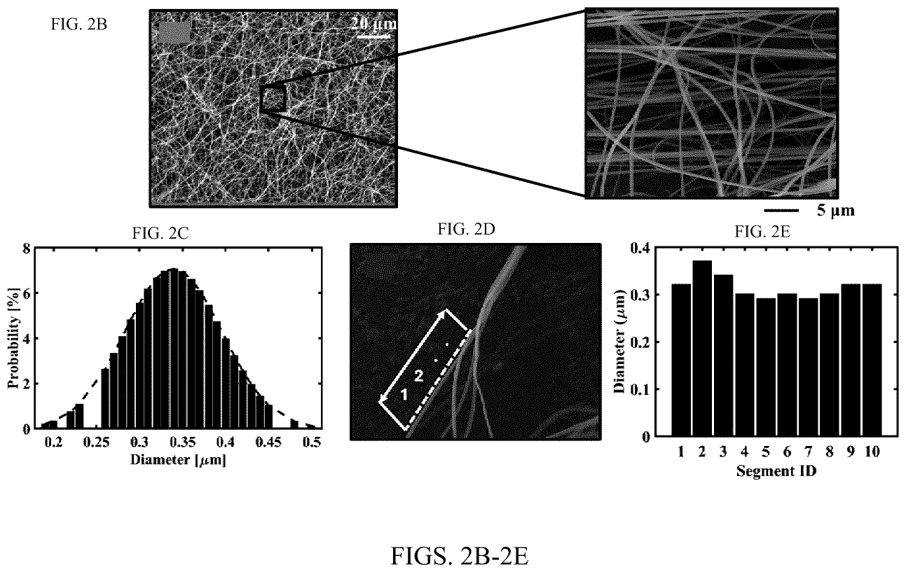

A unidirectional carbon fiber sheet/aluminum foil with area of 457×152 mm² was wrapped around a cylindrical collector that was electrically grounded and rotated at 115 rpm. A low rpm provided random and even deposition of PAN fibers on the carbon fiber sheets. A 6.5 kV DC voltage was used for electrospinning and the distance between the mold and the needle tip was set to ˜14 cm. The electrospinning process was performed for ˜30 s with a syringe pump rate of 0.75 mL/hr. The fabrication setup is schematically presented in FIG. 2A.

For morphological characterization through SEM imaging, a 10-nm-thick gold particle layer was deposited on PAN-coated substrates. A scanning electron microscope (SEM) operated at 10 kV was used for SEM imaging.

### Specimen Preparation

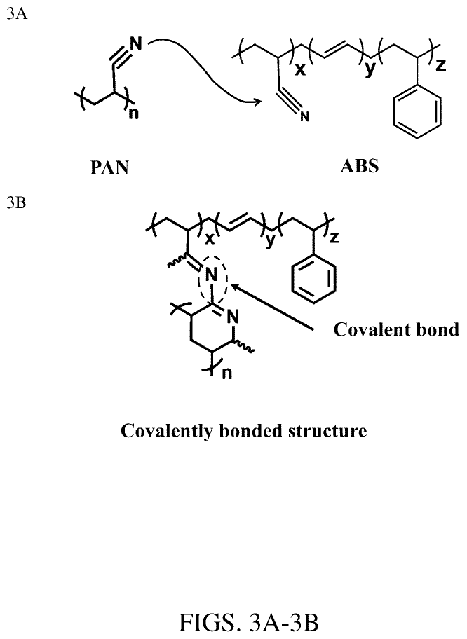

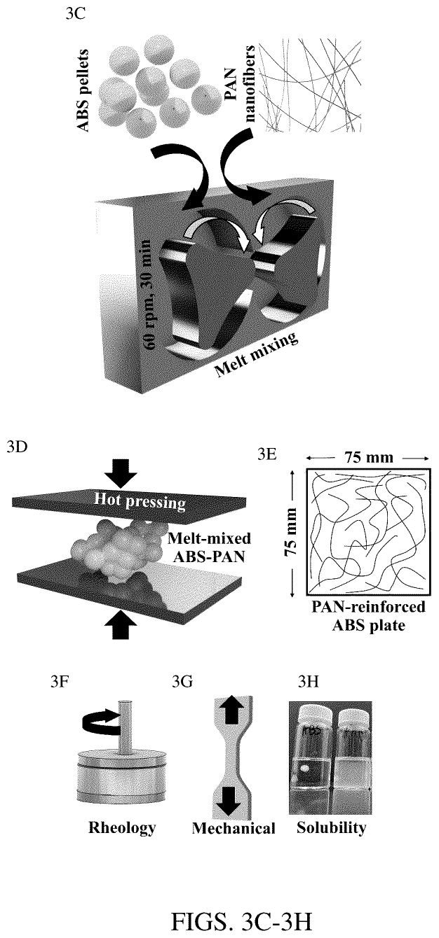

PAN-ABS composites with˜0.01 wt. % PAN fibers were prepared by shear-mixing electrospun PAN nanofibers with ABS pellets, in accordance with the method depicted in FIG. 3C, at 150° C. The total shear-mixing time was limited to 30 min. ABS pellets were added into the mixer and shear mixing was performed for 12 min followed by addition of PAN fibers and their shear mixing. PAN fibers deposited on aluminum foil was used in this step. The shear-mixed PAN-ABS beads were hot-pressed, as depicted in FIG. 3D, at ˜958 kPa for 30 min at different temperatures. The hot-pressed PAN-ABS plates, as shown in FIG. 3D, were cut into small pieces and used in solubility tests. From a (PAN-ABS)_{150° C.} plate, 10-mm-diameter, 1-mm-thick circular discs were cut out for the rheology test. Type V dog bones were cut from the hot-pressed PAN-ABS plate using a water jet cutter for mechanical tests.

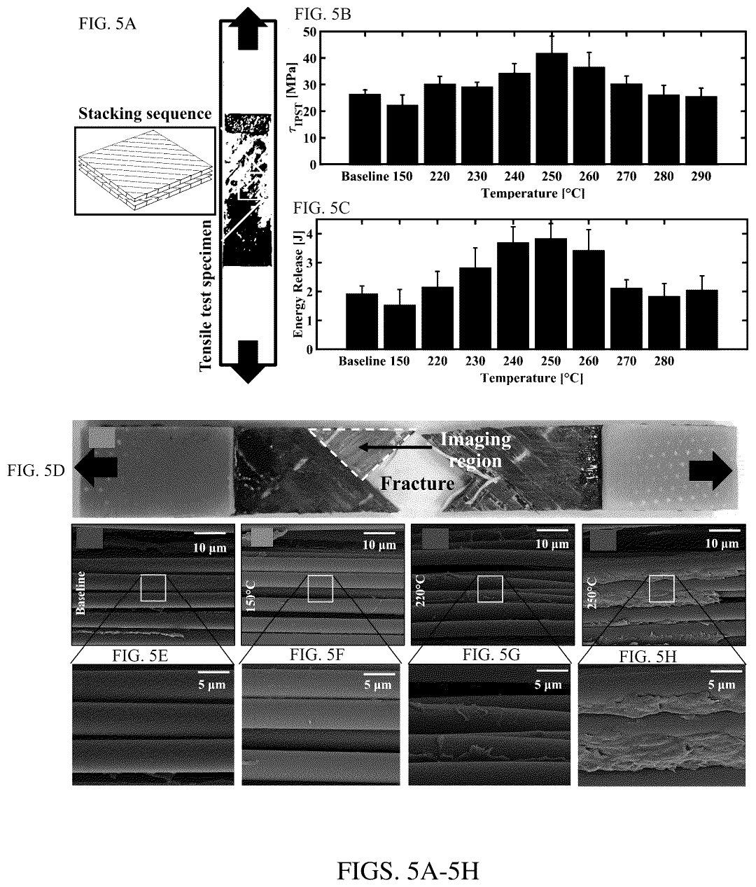

Composite laminates were fabricated by stacking unidirectional carbon fiber sheets in different sequences with both faces coated with electrospun PAN fibers. In-plane shear strength test specimens had four layers of unidirectional carbon fiber sheets symmetrically stacked at +45°. A SEM image of the PAN-coated carbon fibers is provided in FIG. 5A. The sheets were dip-coated in 10 wt. % ABS emulsion in acetone and dried at room temperature for ˜24 h. The ABS-acetone emulsion was prepared by dissolving ˜52.3 g of ABS pellets in 600 ml of acetone using a magnetic stirrer (˜500 rpm). The mixing was performed at room temperature for ˜24 h. ABS-coated carbon fiber sheets were hot-pressed under different temperatures (150° C., and 220° C. to 290° C. at 10° C. intervals) and constant pressure (˜958 kPa) for ˜30 mins.

### Testing Protocols

All rheological measurements were performed using a rotational rheometer equipped with 8-mm-diameter stainless steel parallel plates under an air atmosphere. The rheometer was operated to maintain a 1 N compressive force to ensure zero slip of the composites during testing. The temperature was gradually raised (10° C./min) to the desired level, followed by a ˜30 min isotherm to facilitate the PAN-ABS in situ chemical coupling. After that, the rheometer was cooled down to 150° C. before starting the test. Thereafter, the oscillatory frequency sweep was performed with a shear strain of 0.1% to observe the dynamic response of a PAN-ABS composite in the angular frequency range from 0.01 to 100 rad/s. The shear strain magnitude was set from the linear viscoelastic response regime obtained from an amplitude-frequency sweep study. Neat ABS and PAN-ABS composites heat treated at four different temperatures (220° C.-250° C. in 10° C. intervals) were subjected to the rheological test.

The gel content experiment was performed by a solvent extraction method (S. Dhers et al., Green Chemistry 21, 1596-1601, 2019). Neat ABS, neat PAN, (PAN-ABS) composites heat-treated at 150° C., 220° C., 230° C., 240° C., and 250° C. were subjected to the gel content experiment. Each sample was pre-weighed (Mᵢ) prior to extracting them in a 15 mL solvent mixture of DMSO/CHCl₃ (1:1, w/w) for 48 h in a 20 mL glass vial at 60° C. Thereafter, the specimens were dried in a vacuum oven at 120° C. for 24 h and weighed (M_{d}). Gel fraction was calculated using equation 1, as follows:

$$Gel fraction = \frac{{M}_{d}}{{M}_{i}} \times 100 \qquad ( 1 )$$

All mechanical tests were performed in a displacement-controlled format using a commercial tensile load frame instrumented with a 5 kN load cell and tested in tension until their failure using a displacement rate of 1 mm/min until composite failure. Load vs. crosshead displacement data were sampled at 10 Hz. The average width and thicknesses of the five specimens from each set were measured and used to evaluate the composites' tensile and in-plane shear strength. A total of six specimens were examined within each set.

In the in-plane shear strength test, τ_{IPST} was calculated using equation 2, as follows:

$${τ}_{IPST} = \frac{{P}_{max}}{2 A} \qquad ( 2 )$$

where Pₘₐₓ is the maximum load obtained from the load-displacement curve and A is the cross-sectional area of the specimen.

### Characterization of Composites

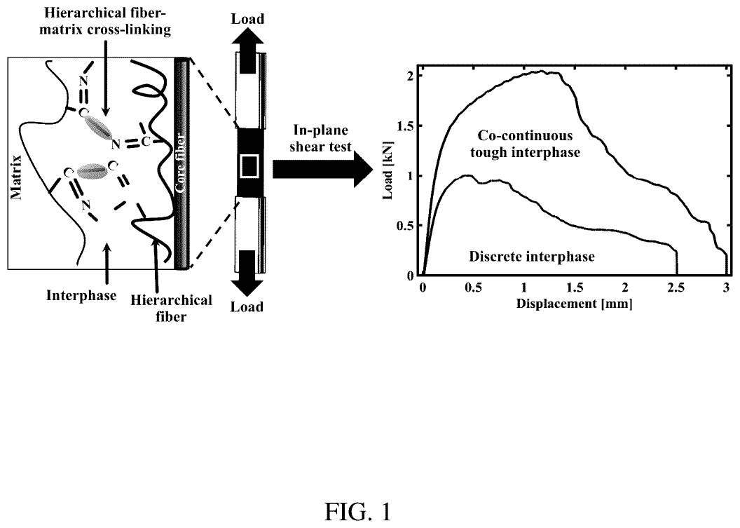

PAN-ABS covalent bonding in the absence of carbon fiber was comprehensively studied through rheology characterization, mechanical testing, and solubility testing. PAN nanofibers, when introduced at the composite's core fiber-matrix interphase and molecularly coupled with the matrix, induces a stiffness gradient within the interphase, thus offering a better fiber-matrix load-transferring pathway. This concept was tested on both continuous and discontinuous carbon fiber-based composite systems. In continuous and discontinuous carbon fiber composites, in-plane shear strength and tensile strength tests, respectively, demonstrated substantial mechanical improvements by virtue of the toughened interphase achieved by the hierarchical nanofiber-matrix bonding. FIG. 1 is a schematic illustration of the fiber-matrix interphase with PAN nanofibers (˜0.35-μm-diameter) deposited on the ˜5-μm-diameter carbon fiber surface creating a hierarchical architecture covalently bonded with the ABS matrix. The above described process demonstrates an effective route for producing a tough fiber-matrix interphase that can be utilized for the design of future fiber-reinforced polymer composites with chemically different constituents.

For the morphological characterization of the electrospun PAN nanofibers, the nanofibers were deposited on aluminum foil via electrospinning, as schematically shown in FIG. 2A. Their morphology was observed by scanning electron microscope (SEM) imaging. The imaging revealed a randomly oriented well-dispersed PAN fiber network, as shown in FIG. 2B. The adoption of a rotating drum approach effectively reduced the potential for introducing coating variations that might result from electrospinning on a stationary unidirectional carbon fiber sheet. This, in turn, provided a higher level of consistency necessary for subsequent mechanical testing of the composite laminates fabricated using these PAN nanofiber-coated carbon fiber sheets.

As shown by the data in FIG. 2C, the analysis further shows that the PAN nanofibers have an average diameter of ˜0.35 μm. The SEM image of PAN fiber (FIG. 2D), when further processed through a customized image processing algorithm, reveals a negligible along-axis standard deviation (˜0.025 μm) in fiber diameter (FIG. 2E).

### PAN-ABS Covalent Bonding Validation

Initial validation of PAN-ABS covalent bonding was performed prior to leveraging the concept for strengthening the fiber-matrix interphase in FRPCs. FIG. 3A shows the chemical structures of PAN (molecular formula [C₃H₃N]n) and ABS. As well known, when PAN is subjected to heat treatment, it produces thermally stable carbon fiber with well-oriented molecular structures. In brief, during thermal processing, the PAN fibers first undergo stabilization at a relatively low temperature (200-300° C.) with a conversion of PAN's C≡N into C═N, resulting in an infusible ladder polymer through cyclization (P. J. Sanchez-Soto, et al., Journal of Analytical and Applied Pyrolysis, 58-59, 155-172, 2001). This thermally induced fusion reaction of acrylonitrile moieties has been well characterized due to the important role they play as intermediates in the formation of carbon fiber (E. Frank et al., Angewandte Chemie International Edition, 53, 5262-5298, 2014). Acrylonitrile-containing copolymers can be conventionally polymerized by free radical polymerization, which results in atactic expression of side group stereochemistry. The combination of segmental rigidity and lack of steric order in PAN yields a disordered helical arrangement of the chains with frustrated packing arrangements (Z. Bashir, Carbon 29, 1081-1090, 1991). The cyclization of PAN can occur through inter- or intra-molecular reactions (J. Simitzis et al., Polymer International 57, 99-105, 2008). In the conditioning of acrylic fibers for conversion to carbon fiber, intramolecular bonding between the nearest neighbors favors the formation of a more ordered turbostratic carbon phase. In contrast, here, interchain reactions are utilized for covalent bonding between the periphery of the electrospun PAN nanofibers and the nitrile-rich region of the ABS terpolymer to mechanically couple the two phases and toughen the composite. More detail about the other chemical steps and related PAN fiber chemistry can be found elsewhere (e.g., T. H. Ko, Journal of Applied Polymer Science 42, 1949-1957, 1991).

ABS (molecular formula [(C₈H₈)ₓ·(C₄H₆)_{y}·(C₃H₃N)_{z}]ₙ) (FIG. 3A) is one of the most widely used thermoplastic polymers primarily known for its impact resistance, toughness, and rigidity. The thermal processing window of ABS (around 250° C.) is congruent with the PAN's thermal window for its initial stabilization. It may be hypothesized that within this common temperature window, PAN and ABS can engage in covalent bonding without any modifications of the ABS's processing parameters. ABS and PAN's nitrile constituents may be converted to C═N, similar to PAN's stabilization process. Thereafter, C═N from ABS and PAN can react with each other to form intermolecular C—N. The expected chemical reaction and the chemically bonded PAN-ABS structure is shown in FIG. 3B. Notably, several bonding modes can occur between acrylonitrile-bearing molecules. However, the temperatures used in the present experiments are in the range of previously reported crosslink formation through intermolecular addition (e.g., X. Liu et al., Macromolecules 50, 244-253, 2017).

˜0.01 wt. % electrospun PAN fibers were shear-mixed with ABS (as shown in FIG. 3C), and hot-pressed (as shown in FIG. 3D), resulting in a PAN-ABS composite represented by (PAN-ABS)_{T}, with T being the press temperature. The aforementioned wt. % of PAN was selected, assuming that ˜30 s of electrospinning time used in this study could only integrate PAN nanofibers at such ultra-low concentration in the bulk composites. The shear-mixed specimens were hot-pressed at different temperatures to obtain the PAN-ABS composite (as depicted in FIG. 3E) with various covalent bonding levels. The following three indirect tests were performed to validate the PAN-ABS covalent bonding hypothesis: rheology study (FIG. 3F), mechanical characterization (FIG. 3G), and solubility test (FIG. 3H).

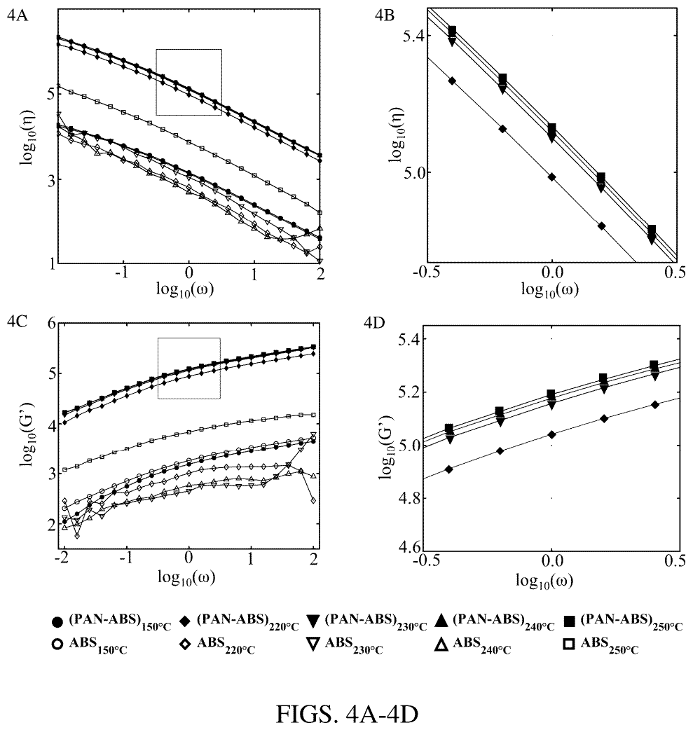

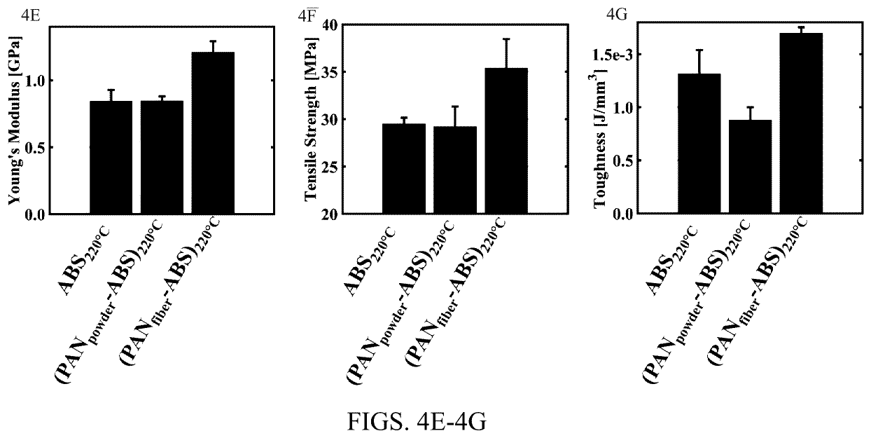

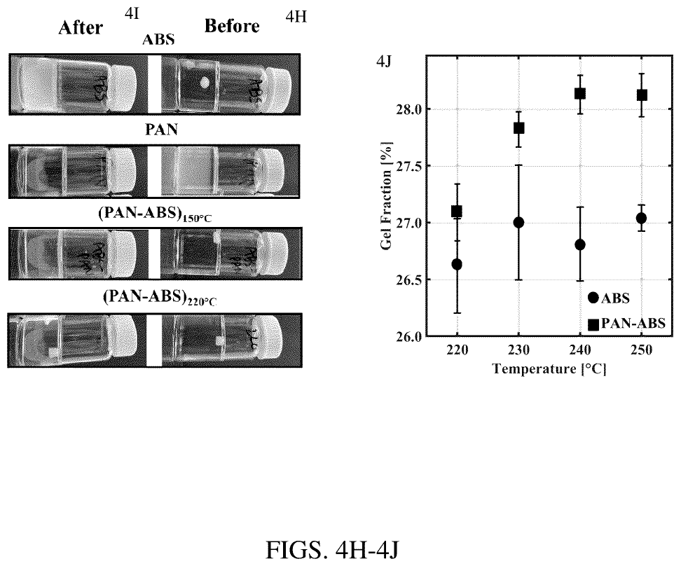

Polymer chain scission and fusion during polymer-polymer covalent bonding results in microstructural transformation, thus influencing their viscoelastic responses. For example, increase in rheological parameters (storage and loss modulus and viscosity) may be attributed to the increase in molecular weight due to polymer-polymer covalent bonding (H. H. Winter et al., Journal of Rheology, 30, 367-382, 1986). Dynamic oscillation rheology is widely used as an indirect way for polymer-polymer bonding validation. The rheological responses during frequency sweep for PAN-ABS specimens and neat ABS heat-treated at different temperatures are shown in FIGS. 4A-4B. Compared to neat ABS, the PAN-ABS composites exhibit dramatic improvement in complex viscosity (η) and storage modulus (G′). It was observed that the composites' p gradually increases with their heat treatment temperature (FIGS. 4A-4B). In fact, at the lower frequency, (PAN-ABS)_{220° C.} has η two orders of magnitude higher than neat ABS. For example, at 0.01 rad/s, η=11,778.6 Pa·s and 1,475,600 Pa·s for neat ABS and (PAN-ABS)_{220° C.}, respectively. They further increased to 2,233,700 Pa·s for (PAN-ABS)_{250° C.} specimens (FIG. 4B). This observation may indicate more PAN-ABS covalent bonding with increasing heat treatment temperature. Like q, the frequency-dependent G′ behaved in a similar fashion (FIGS. 4C-4D). For instance, at 0.01 rad/s, (PAN-ABS)_{220° C.} has ten times higher G′ than neat ABS. An upsurge in molecular weight due to PAN-ABS covalent bonding may be responsible for such behavior of G′. It was also found that neat ABS's rheological properties do not change with heat treatment temperature, which is consistent with the solubility test data below. As an ultralow concentration of PAN was maintained (0.01 wt. %), the reinforcing effect due to the self-cyclization of PAN may be neglected. Hence, these observed trends in the rheological properties of the PAN-ABS composites may be an indicator of PAN-ABS covalent bonding.

Uniaxial tensile tests of PAN-ABS composites were performed as another indirect way to confirm the PAN-ABS covalent bonding. It may be hypothesized that constituents of PAN-ABS composite, when chemically bonded, can exhibit enhanced mechanical properties. In addition to casting PAN nanofiber-based ABS composites, PAN powder-based composites (PAN_{powder}-ABS) were also prepared and tested in order to characterize the effect of PAN's architecture on the bulk mechanical properties. In general, the composites' strain vs. stress response exhibits a linear regime followed by some yielding and failure. The composites' Young's moduli (E) were determined by linear least square regression of the strain vs. stress curves' initial portion (from 0 to 0.01% strain regime) that shows (PAN-ABS)_{220° C.} composites have an E ˜60% higher than neat ABS and (PAN_{powder}-ABS)_{220° C.}, with results shown in FIG. 4E. Additionally, (PAN-ABS)_{220° C.} specimens also have ˜20% and ˜50% higher tensile strength and fracture toughness, respectively, than the pristine counterpart, with results shown in FIGS. 4F-4G. Interestingly, (PAN_{powder}-ABS220°) c did not exhibit such improvement in mechanical properties. In fact, their E and tensile strength remained the same as the neat ABS, and the toughness was even compromised. While the PAN is still able to covalently bond with ABS, the powder form factor has less surface area; therefore, it can only offer a limited number of functional groups (C≡N) to facilitate PAN-ABS bonding. On the other hand, the electrospun nanofiber scaffold has a high surface area, and thus, can provide more C≡N to be chemically bonded with the ABS.

The molecular alignment in electrospun PAN nanofibers may also add some reinforcement effect; however, it would be negligible due to their ultra-low concentration (0.01 wt. %) within the bulk composite. It may be concluded that the long, entangled PAN and ABS chains were covalently bonded, resisting their unraveling under applied loading. Additionally, such bonded chains would be hard to separate, thus providing more tortuous pathways to crack propagation during failure. Such phenomena ultimately resulted in a composite with superior E and tensile strength. Moreover, the hierarchical network of the PAN fibers can absorb more energy prior to failure, thereby improving the toughness of the composites. This finding confirms the contribution of the PAN fibers' hierarchical architecture to enhance the composites' mechanical properties. Shear mixing can lead to the separation, breakage, and shortening of PAN fibers, potentially impacting the mechanical properties of PAN-ABS composites. Maintaining the aspect ratio of reinforcing nanomaterials is beneficial for improving the mechanical properties of the resulting composites. Thus, careful selection of shear mixing parameters (e.g., torque and mixing time) is crucial for preventing fiber fragmentation and mitigating its adverse effects on the mechanical properties of the final composites.

The covalently bonded PAN-ABS composites were investigated via a solubility study. Here, specimens were added to a mixture of dimethyl sulfoxide (C₂H₆OS)/chloroform (CHCl₃) as a common solvent (1:1, w/w, 48 h at 60° C.). FIG. 4H shows snapshots of the different specimens. FIG. 4I shows that neat ABS, neat PAN, (PAN_{powder}-ABS220°)_{220° C.}, and (PAN_{fiber}-ABS)_{150° C.} were completely dissolved. In contrast, (PAN-ABS)_{220° C.} was not dissolved, which indicates PAN-ABS covalent bonding. These results further emphasize the significance of maintaining the fibrous structure of PAN within PAN-ABS composites to achieve composites with enhanced mechanical properties.

The gel fractions of (PAN_{fiber}-ABS) composites prepared via various heat treatment temperatures are summarized in FIG. 4J. It was herein found that the gel fraction increases with the heat treatment temperature (220° C. to 240° C.) for (PAN_{fiber}-ABS) composites. A higher temperature may promote more PAN-ABS bonding, thus causing an upsurge in the gel fraction. However, the gel fraction did not significantly increase after 240° C., as indicated by the plateau in FIG. 4J. At this temperature, a saturation point may have been reached where all the available C≡N on the PAN fiber surface became engaged with the ABS through covalent bonding. Although this result shows that PAN-ABS bonding can be controlled by tuning the processing temperature, it also demonstrates that temperature above a threshold point may not necessarily help in more PAN-ABS bonding. Overall, the solubility test results justify a hypothesis that PAN and ABS engage in covalent bonding when subjected to a suitable temperature.

In general, these tests demonstrate that the hierarchical PAN fibers and ABS become covalently bonded when subjected to a suitable heat treatment, thus resulting in a tougher fiber reinforced polymer composite design.

### Mechanical Properties of the Composites

This experiment demonstrates the ability of the PAN fibers to covalently bond with the polymer matrix at the carbon fiber-ABS matrix interphase to enhance the toughness of the bulk composites. From the rheological study and solubility test, it was found that a higher heat treatment temperature may promote more PAN-ABS bonding. Therefore, additional improvement in the mechanical performance of the bulk composites may be achieved by optimally selecting the heat treatment temperature. Laminates with symmetric unidirectional carbon fiber sheet laid up at [+45°/−45° ]₂ were prepared by using different heat treatment temperatures, and their in-plane shear strength (τ_{IPST}) was characterized as a direct measure of the carbon fiber-matrix interfacial strength (test depicted in FIG. 5A).

It was herein observed that the peak load and the yielding of the composites increase with the heat treatment temperature. The energy release prior to the complete failure of the composites was evaluated by calculating the area under the load-displacement curves. The average τ_{IPST} and energy release results are summarized in FIGS. 5B and 5C, respectively. It was herein found that both these parameters exhibit a similar trend with heat treatment temperature. For example, the (PAN-ABS)_{220° C.} composites have ˜15% and ˜12% increment in τ_{IPST} and energy release than neat ABS composites that gradually increased to a maximum of ˜60% and ˜100%, respectively, as found in (PAN-ABS)_{250° C.}. Such improvement is justified as the number of covalently bonded PAN-ABS molecules at the fiber-matrix interphase increases with heat treatment temperature. These covalently bonded ABS-PAN molecules provide better adhesion with the carbon fibers.

To experimentally validate the observed increase in bonding at the fiber surface, the fractured surfaces (FIG. 5D) of the tested specimens were examined by SEM. Micrographs at different magnifications of four different composites are shown in FIGS. 5E-5H. Although complete removal of the polymer matrix from the fiber surface was observed in neat ABS and (PAN-ABS)_{150° C.} composites, (PAN-ABS)_{220° C.} composites consistently exhibited a rough fracture plane with some polymers adhered to the fiber surfaces. The adhered polymer quantity was more prevalent in (PAN-ABS)_{250° C.} composites. These results are likely attributed to greater covalent bonding between PAN and ABS in the (PAN-ABS)_{250° C.} specimens than the (PAN-ABS)_{220° C.} specimens.

The decrement in τ_{IPST} and fracture energy beyond 250° C. was due to the thermal degradation of ABS. Nevertheless, these results demonstrate that inverse anchoring of hierarchical PAN fibers with the ABS matrix at the carbon fiber-matrix interphase conducted at an optimally selected heat treatment temperature significantly enhances the interfacial strength and toughness of the bulk composites.

Finally, mechanical tests were conducted on PAN nanofiber-enhanced discontinuous carbon fiber (DCF)-reinforced ABS composites. To explore the influence of multiscale architecture of the nanofibers on the mechanical properties of DCF-based composites, various diameter PAN nanofibers were electrospun on the DCF sheets, and these were stacked together to obtain the composite laminates. Here, the hypothesis is that smaller diameter PAN nanofibers will have better mechanical properties due to better PAN chain alignment within the individual nanofibers. In addition, smaller diameter nanofibers should have a higher surface area and therefore should offer more reactive nitrile groups to covalently bond with the ABS matrix, thus providing better mechanical properties.

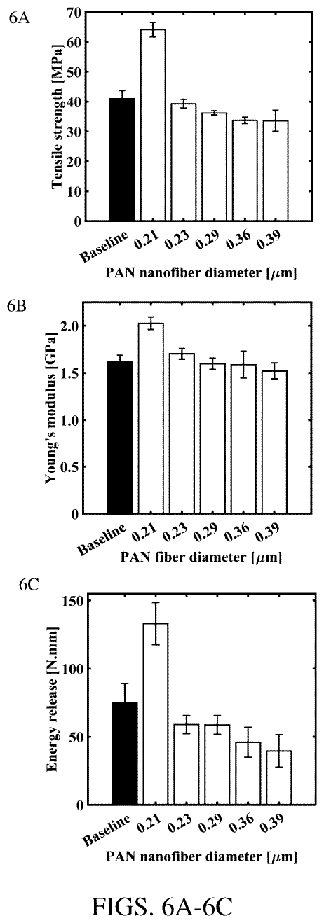

To assess the maximum influence of PAN nanofiber diameter on the mechanical properties of the FRPCs, nanofibers aligned in the loading direction were deposited. Such geometrical alignment of these nanofibers in the loading direction maximizes the mechanical properties. Their tensile strengths are summarized in FIG. 6A. PAN_{0.21 μm} composites exhibited the highest tensile strength of 64 MPa, ˜56% higher than the pristine DCF-ABS baseline. Tensile strength decreased with increasing nanofiber diameter, approaching the strength of pristine DCF-ABS composites. A similar trend was observed for E where PAN_{0.21 μm} composites had an E ˜2 GPa, compared to 1.6 GPa for pristine DCF. For PAN_{0.39 μm} composites, E dropped to ˜1.5 GPa, as shown by the data in FIG. 6B. Fracture energy also followed this trend, with PAN_{0.21 μm} composites showing the highest fracture energy of 133 N-mm, ˜175% higher than the pristine CF composite, as shown by the data in FIG. 6C. Larger fibers, with less tensile strength and surface area, resulted in less covalent bonding with ABS, leading to less pronounced mechanical properties similar to the pristine DCF composite. Insufficiently bonded larger nanofibers, characterized by lower mechanical properties due to reduced alignment of PAN chains, may act as local defects, thereby deteriorating the overall mechanical performance of the composites. Overall, the mechanical test results presented in FIGS. 6A-6C validate the hypothesis that increased PAN-ABS covalent bonding with the higher surface area of the PAN nanofibers, combined with axially aligned PAN chains, enhances interfacial strength of the composites by promoting stronger non-bonded van der Waals interactions between the crosslinked nanofibers and carbon fibers.

### CONCLUSIONS

The results presented herein demonstrate a polymer composite with nanofiber scaffolding at the core fiber-matrix interphase and its covalent bonding with the polymer matrix. The resulting composite exhibits outstanding fiber-matrix interfacial strength and toughness. The presently described approach is straightforward yet practical for producing a composite with superior fiber-matrix interfacial properties. The approach was demonstrated on a composite containing PAN in a hierarchical arrangement in an ABS polymer matrix. These components were selected in view of their compatible nitrile groups to facilitate PAN-ABS covalent bonding upon suitable heat treatment. Electrospinning was employed as a scalable, low-cost method to fabricate hierarchical PAN nanofibers and integrate them into different substrates. SEM imaging revealed that the electrospinning parameters used in the present experiments resulted in a randomly distributed network of PAN nanofibers with consistent morphology.

PAN and ABS were shear-mixed and hot-pressed at various temperatures to produce the PAN-ABS composites. PAN-ABS covalent bonding was confirmed by rheology, mechanical, and solubility tests. The PAN-ABS composites exhibited η and G′ parameters that were orders of magnitude higher than neat ABS, as found by the rheology testing. The uniaxial tensile test confirmed that hierarchical PAN fibers enhanced the ABS's E, ultimate strength, and fracture toughness by ˜60%, ˜20%, and 50%, respectively. It was herein found that the hierarchical architecture of the PAN fibers plays a crucial role in achieving such improvement in mechanical properties. The solubility test revealed that PAN-ABS composites heat treated at a suitable temperature did not dissolve in a solvent, while neat PAN, ABS, and uncrosslinked PAN-ABS composites were dissociated. It was also observed that the gel fraction of the PAN-ABS composites increases with the heat treatment temperature. While all these results are crucial for understanding the behavior of the covalently bonded PAN-ABS composites, it is worth noting that these dramatic improvements were achieved by introducing a very small amount of the PAN nanofibers (as low as 0.01 wt. %) in the ABS and processing them together within the ABS's processing temperature. In view of these results, the PAN-ABS composites may be used in additive manufacturing methods to produce novel higher strength 3D-printed ABS structures.

When integrated at the fiber-matrix interphase of an FRPC system, these nanofibers, covalently bonded with ABS, create an interphase with intermediate stiffness. Such interphases serve as a co-continuous network at discontinuous-type fiber-matrix interphases, thus offering a better fiber-matrix load-transferring pathway. These FRPCs with nanoengineered fiber-matrix interphases exhibit superior in-plane shear strength and toughness in FRPC (˜60% and % 100 improvement, respectively). The key criterion for these profound mechanical improvements is the ability of the nitrile group within the resin to undergo the necessary reactions and form covalent bonds with the nitrile groups in the PAN nanofibers. This methodology can be applied to other nitrile-containing polymer matrices, such as styrene-acrylonitrile copolymer thermoplastic and acrylonitrile-butadiene copolymer rubber, possibly having widespread applicability in traditional FRPCs. The presently described approach has the potential to replace the chemically intensive processes conventionally used for strengthening core fiber-matrix interphases.

While there have been shown and described what are at present considered the preferred embodiments of the invention, those skilled in the art may make various changes and modifications which remain within the scope of the invention defined by the appended claims.

What is claimed is:

1. A fiber reinforced composite material comprising the following components:
(i) polyacrylonitrile (PAN) particles containing an acrylonitrile content of 80-100 mol % and present in an amount of 0.001-15 wt % by weight of components (i) and (ii); and
(ii) a nitrile-containing polymer having a composition different than the PAN particles;
wherein nitrile groups in component (i) are crosslinked with nitrile groups of component (ii), and wherein said PAN particles are dispersed in component (ii).

2. The composite material of claim 1, wherein said PAN particles are present in an amount of 0.001-10 wt %.

3. The composite material of claim 1, wherein said PAN particles are present in an amount of 0.001-5 wt %.

4. The composite material of claim 1, wherein said PAN particles are present in an amount of 0.001-2 wt %.

5. The composite material of claim 1, wherein said PAN particles are PAN fibers.

6. The composite material of claim 5, wherein said PAN fibers have a diameter of about 0.01 micron to 50 microns.

7. The composite material of claim 5, wherein said PAN fibers have a diameter of about 0.01 micron to 10 microns.

8. The composite material of claim 5, wherein said PAN fibers have a diameter of about 0.01 micron to 1 micron.

9. The composite material of claim 1, wherein component (ii) comprises a copolymer of acrylonitrile and at least one of styrene and/or butadiene.

10. The composite material of claim 1, wherein component (ii) is selected from the group consisting of acrylonitrile-butadiene-styrene (ABS), styrene-acrylonitrile (SAN), nitrile-butadiene rubber (NBR), and acrylonitrile-styrene-acrylate (ASA) copolymer.

11. The composite material of claim 1, wherein component (ii) is ABS.

12. The composite material of claim 1, further comprising the following component:
(iii) a filler component comprising particles having a composition other than components (i) and (ii), wherein component (iii) is present in an amount of 0.1-60 wt % by weight of components (i) and (ii).

13. The composite material of claim 12, wherein component (iii) is selected from the group consisting of carbon particles, basalt particles, polymer particles, natural particles, ceramic particles, and glass particles.

14. The composite material of claim 12, wherein component (iii) comprises carbon particles.

15. The composite material of claim 14, wherein said carbon particles are carbon fibers.

16. A method of producing a particle-reinforced composite material, the method comprising:
(a1) mixing polyacrylonitrile (PAN) particles containing an acrylonitrile content of 80-100 mol % and a nitrile-containing polymer having a composition different than the PAN particles to form a precursor mixture; or alternatively,
(a2) disposing polyacrylonitrile (PAN) particles containing an acrylonitrile content of 80-100 mol % onto a filler component comprising particles having a composition other than components (i) and (ii) to produce a composite preform, and mixing the composite preform with said nitrile-containing polymer having a composition different than the PAN particles to create an infiltrated composite preform; and
(b) hot-pressing the precursor mixture or infiltrated composite preform at a temperature conducive for crosslinking of nitrile groups to form the particle-reinforced composite material;
wherein the particle-reinforced composite material comprises the following components:
(i) said polyacrylonitrile (PAN) particles containing an acrylonitrile content of 80-100 mol % and present in an amount of 0.001-15 wt % by weight of components (i) and (ii); and
(ii) said nitrile-containing polymer having a composition different than the PAN particles;
wherein nitrile groups in component (i) are crosslinked with nitrile groups of component (ii), and wherein said PAN particles are dispersed in component (ii) either in the absence of the filler component or disposed on the filler component.

17. The method of claim 16, wherein said temperature is within a range of 160-300° C.

18. The method of claim 16, wherein said temperature is within a range of 220-260° C.

19. The method of claim 16, wherein component (ii) comprises a copolymer of acrylonitrile and at least one of styrene and/or butadiene.

20. The method of claim 16, wherein component (ii) is selected from the group consisting of acrylonitrile-butadiene-styrene (ABS), styrene-acrylonitrile (SAN), nitrile-butadiene rubber (NBR), and acrylonitrile-styrene-acrylate (ASA) copolymer.

21. The method of claim 16, wherein component (ii) is ABS.

22. The method of claim 16, wherein the disposing step in step (a2) comprises electrospinning the PAN particles containing an acrylonitrile content of 80-100 mol % onto a filler sheet in which filler fibers are woven or non-woven, wherein said filler sheet with electrospun PAN particles disposed thereon corresponds to the composite preform.

23. The method of claim 22, wherein component (iii) is selected from the group consisting of carbon particles, basalt particles, polymer particles, natural particles, ceramic particles, and glass particles.

24. The method of claim 22, wherein component (iii) comprises carbon particles, such as carbon fibers.

25. The method of claim 22, wherein said electrospun PAN particles are a web or network of PAN fibers disposed on the filler sheet.
